(19) United States
(12) Patent Application Publication
(10) Pub. No.: US 2024/0275641 A1
(43) Pub. Date: Aug. 15, 2024

(54) METHODS, ARCHITECTURES, APPARATUSES AND SYSTEMS DIRECTED TO ADAPTIVE REFERENCE SIGNAL CONFIGURATION

(71) Applicant: InterDigital Patent Holding, Inc., Wilmington, DE (US)

(72) Inventors: Arman Shojaeifard, London (GB); Alain Mourad, Ascot (GB); Afshin Haghighat, Ile-Bizard (CA); Ibrahim Hemadeh, Hemel Hempstead (GB)

(21) Appl. No.: 18/568,102

(22) PCT Filed: Jun. 9, 2022
(86) PCT No.: PCT/US2022/032849

§ 371 Date: Dec. 7, 2023

(30) Foreign Application Priority Data
Jun. 11, 2021 (EP) 21178929.2
Apr. 7, 2022 (EP) 22167141.5

(51) Int. Cl. H04L 25/02; H04L 5/00

(52) U.S. Cl. CPC H04L 25/0232; H04L 5/0048; H04L 5/0085

(57) ABSTRACT

Procedures, methods, architectures, apparatuses, systems, devices, and computer program products directed to adaptive reference signal configuration are described. A method for adapting a reference signal configuration may be implemented in a WTRU. For example, the WTRU may receive a transmission e.g., from a base station according to one or more first reference signal configurations. For example, a channel estimation measurement may be performed for the received transmission based on the indicated one or more first reference signal configurations. For example, one or more second reference signal configurations (e.g., to be used for a subsequent transmission) may be selected from a plurality of reference signal configurations based on the channel estimation measurement. For example, an indication of the selected one or more second reference signal configuration may be transmitted (e.g., to the base station).

### CROSS-REFERENCE TO RELATED APPLICATIONS

This application claims the benefit of European Patent Application No. 21178929.2, filed Jun. 11, 2021, and European Patent Application 22167141.5, filed Apr. 7, 2022, each of which is incorporated herein by reference in its entirety.

### TECHNICAL FIELD

The present disclosure is generally directed to the fields of communications, software and encoding, including, for example, to methods, architectures, apparatuses, systems directed to adaptive reference signal configuration, e.g., with any of artificial intelligence (AI) and machine learning (ML).

### BRIEF SUMMARY

Briefly stated, according to one embodiment of the present disclosure, a method implemented in a wireless transmit/receive unit (WTRU) includes receiving, from a base station, a transmission according to one or more first reference signal configurations. A channel estimation measurement is performed for the received transmission based on the one or more first reference signal configurations. An indication is transmitted, to the base station, of one or more second reference signal configurations to be used for a subsequent transmission, wherein the one or more second reference signal configurations are selected from a plurality of reference signal configurations based on the channel estimation measurement.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of a composite channel estimation procedure based on user-specific reference signals;

FIG. 3 is a diagram illustrating an example of a 5G demodulation reference signal (DMRS) configuration;

FIG. 4 is a system diagram illustrating a first example of an adaptive reference signal configuration method;

FIG. 5 is a diagram illustrating an example of a message exchange for the first example of adaptive reference signal configuration method;

FIG. 6 is a system diagram illustrating a second example of adaptive reference signal configuration method;

FIG. 7 is a diagram illustrating an example of a message exchange for the second example of adaptive reference signal configuration method;

FIG. 8 is a diagram illustrating an example of a reference signal adaption;

FIG. 9 is a diagram illustrating an example of a procedure for reference signal adaptation;

FIGS. 10A, 10B and 10C are diagrams illustrating examples of AI/ML-based determination of a reference signal configuration;

FIG. 11 is a diagram illustrating an example of a method for adapting a reference signal configuration; and

FIG. 12 is a diagram illustrating an example of a method for reference signal adaptation by which the density of a reference signal configuration may be modified.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

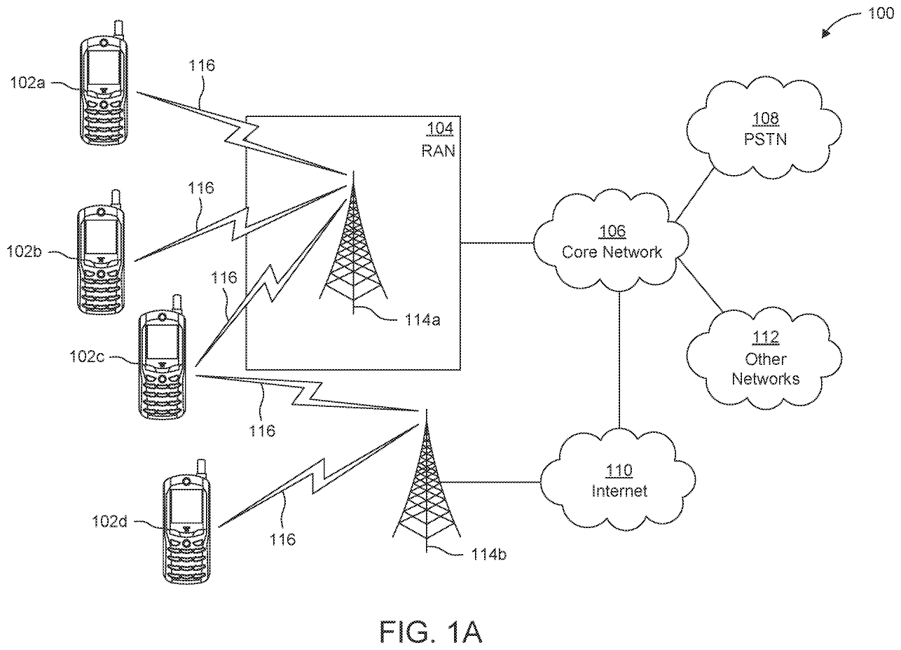

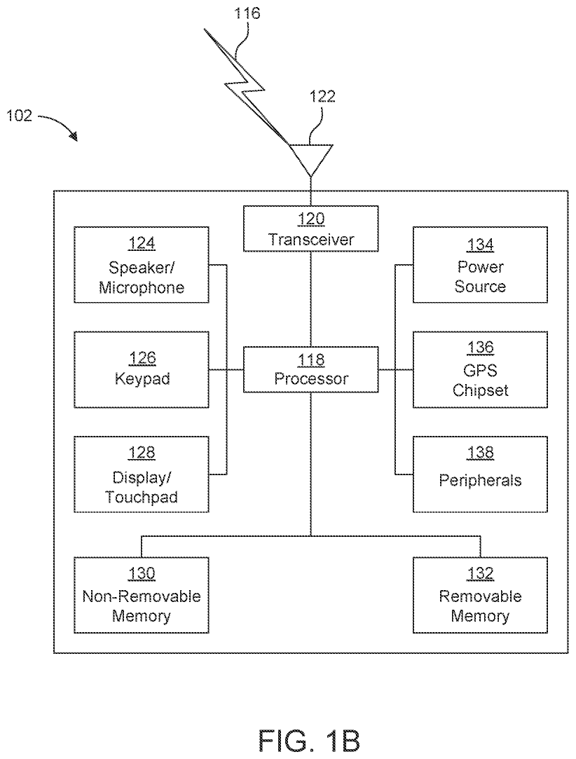

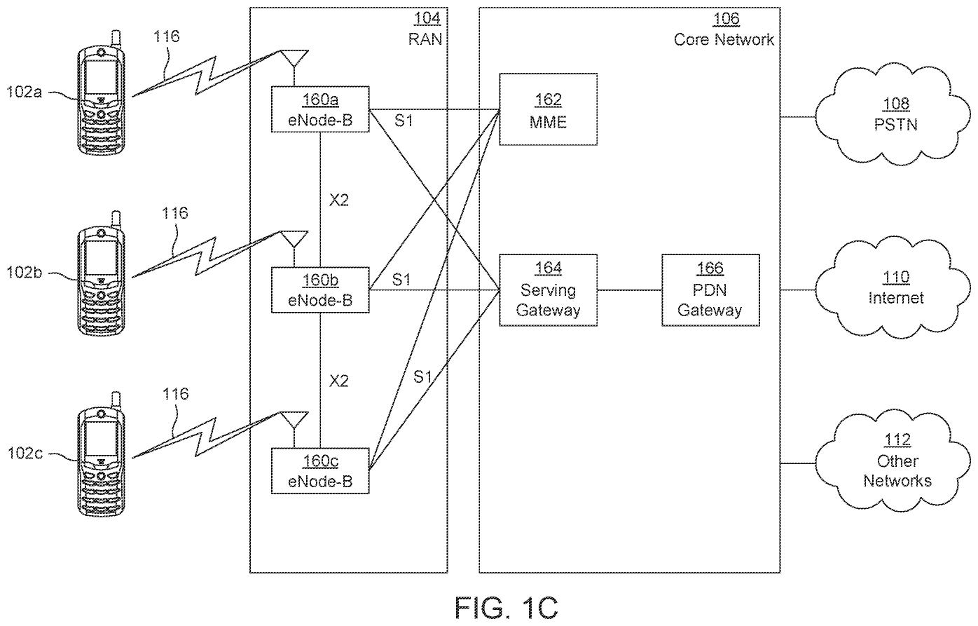

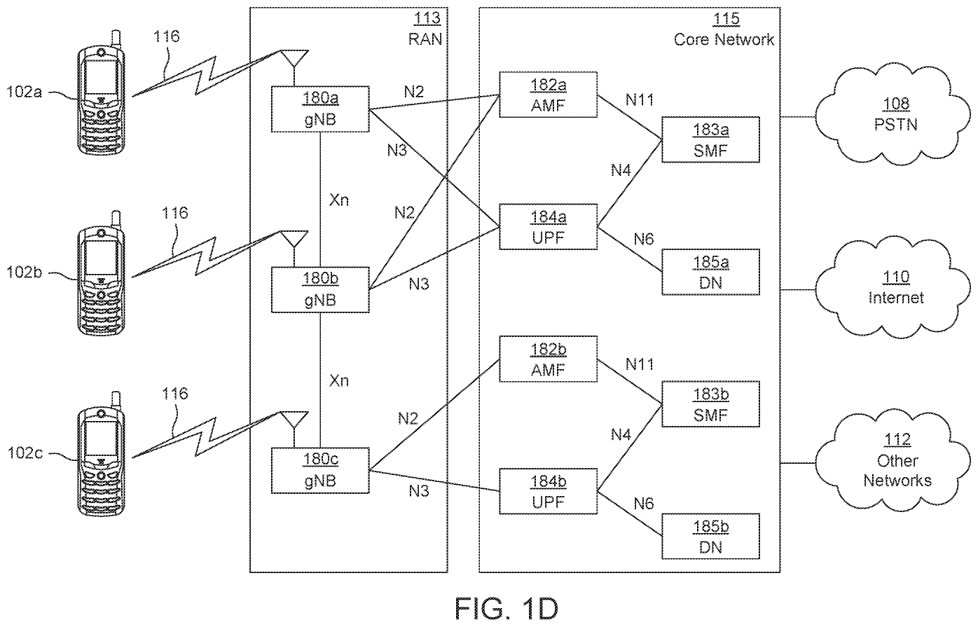

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from abase station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11 ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Example of Channel Estimation

Pilot-based schemes may be used in networks, for example, to enable composite channel estimation (CE) coherent demodulation of any of pre-coded and beamformed signals, e.g., at the receivers. For example, demodulation reference signals (DMRS) may be used in 5G New Radio (NR) for this purpose.

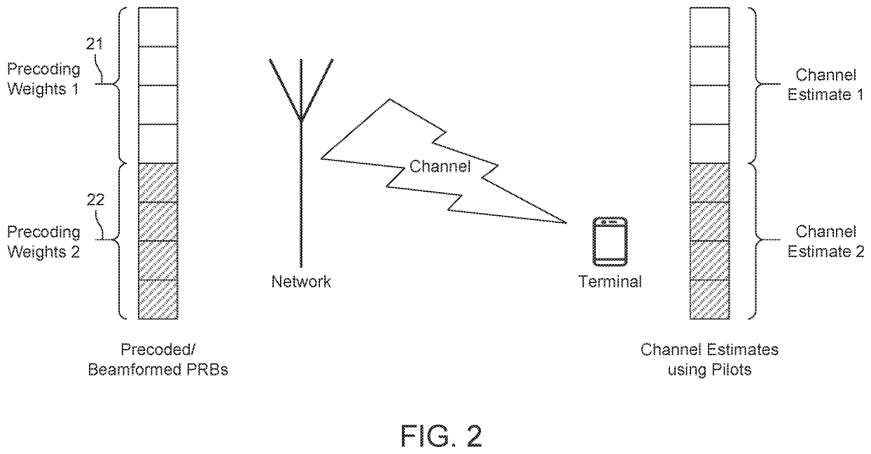

FIG. 2 is a diagram illustrating an example of a composite channel estimation procedure based on (e.g., user-specific) reference signals. For example, composite channel estimation (CE) coherent demodulation of any of pre-coded and beamformed signals may be performed by applying the same precoding (e.g., beamforming) weights to the reference signals that may be used on any of the downlink and uplink physical channels. For example, precoding weights 21, 22 may be applied to physical resources blocks (PRBs) before transmission. The same precoding weights 21, 22 (e.g., that may be known to the receiver) may be applied at the receiver side on the reference signals for channel estimation. For example, a first channel estimation may be based on first precoding weights 21 and a second channel estimation may be based on second precoding weights 22.

Different configurations of DMRS may be used in a 5G network to cater for different deployment scenarios. For example, different configurations of DMRS may include various (e.g., different) time and frequency densities of reference signals. A configuration of DMRS, such as e.g., any of density and position in resource grid, orthogonal cover codes, duration, starting symbol, etc., may impact (e.g., dictate) the CE performance. For example, the density of reference signal transmission in any of time and frequency may be configured according to any of time and frequency selectivity (e.g., sensitivity) of the communication channel. For example, a (e.g., more) dense distribution of reference signals in the frequency domain may allow a higher frequency selectivity of the communication channel (e.g., than a less dense distribution). For example, more frequent transmissions of reference signals may allow (e.g., to support) a higher rate of fading in the time domain.

Mechanisms (e.g., methods, architectures, apparatuses and systems) for adaptive transmission of reference signals (RS) based on the terminal indication of the (e.g., preferred) configuration(s) of RS to the network are described herein. For example, the selection of a RS (e.g., DMRS) configuration by the terminal may be based on (e.g., instantaneous) measurements, that may be performed by the terminal, e.g., based on any CE schemes. In another example, a RS (e.g., DMRS) configuration may be selected by the terminal by applying any of an artificial intelligence and a machine learning (AI/ML)-based analysis on any of (e.g., collected) CE configurations and CE measurement(s).

For the sake of clarity, embodiments are described herein with the example of downlink DMRS. Embodiments described herein are not limited to downlink DMRS and may be applicable to any other reference signals (such as e.g., any of CSI-RS, and uplink reference signals). Throughout embodiments described herein the terms “reference signal configuration”, “DMRS configuration”, “configuration of reference signals” and “configuration of DMRS” may be used interchangeably to designate a reference signal configuration. Throughout embodiments described herein the terms “default reference signal configuration” and “first reference signal configuration” may be used interchangeably. Throughout embodiments described herein the terms “second reference signal configuration”, “(e.g., preferred) reference signal configuration” and “selected reference signal configuration” may be used interchangeably to designate a reference signal configuration that may be selected (e.g., requested), e.g., by the WTRU for a subsequent transmission. Throughout embodiments described herein the terms “terminal”, “receiver”, “WTRU” may be used interchangeably to designate any apparatus capable of receiving a wireless signal, performing a channel estimation and selecting a (e.g., preferred) reference signal configuration. In embodiments described herein any of AI and ML may be referred to as AI/ML. In embodiments described herein, the terms “reference signal” and “pilot” may be used interchangeably.

Throughout embodiments described herein the terms “explicitly” and “explicit”, when associated with e.g., any of “transmit”, “indicate”, and “report” a piece of information may be used to designate a transmission (of e.g., a message) including an (e.g., explicit) information element indicating that piece of information. The message including (e.g., explicit) information may be included in any of the physical uplink control channel (PUCCH) and uplink control information (UCI).

Throughout embodiments described herein the terms “implicitly” and “implicit”, when associated with e.g., any of “transmit”, “indicate”, and “report” a piece of information may be used to designate a transmission (of e.g., any type of information) in a (e.g., specific) resource that may be associated with that piece of information. The (e.g., specific) resource may be, for example, any of a specific PUCCH resource, a random-access channel (RACH) resource, a sounding reference signal (SRS) resource, and a spatial relation information (e.g., spatialrelationInfo) resource etc.

Throughout embodiments described herein the terms “serving base station”, ‘base station”, “gNB”, collectively “the network” may be used interchangeably to designate any network element such as e.g., a network element acting as a serving base station. Embodiments described herein are not limited to gNBs and are applicable to any other type of serving base stations.

3GPP standards provide some flexibility in configuration of pilots to cater for different WTRU capabilities and use cases. For example, for 5G NR physical downlink shared channel (PDSCH) DMRS, there may be configurations including any of configuration type 1, configuration type 2, mapping type A, mapping type B, starting symbol for mapping type A, single versus double symbol DMRS, DMRS additional positions, and duration.

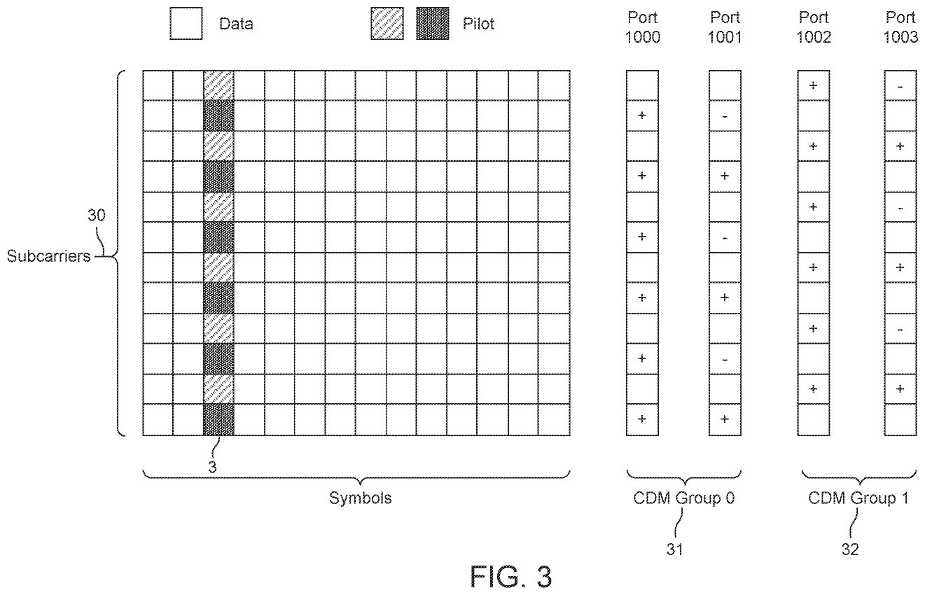

FIG. 3 is a diagram illustrating an example of a 5G NR DMRS configuration. The DMRS configuration may be a single symbol configuration type 1 that may support up to 4×4 MIMO. FIG. 3 shows an example DMRS pattern over one symbol and one resource block in 5G NR with configuration type 1, mapping type A, and starting symbol 3, using downlink antenna ports 1000, 1001, 1002, and 1003 with CDM Group 0 31 and CDM Group 1 32 across the frequency 30 and code domains.

For example, the CE performance may depend on any of the configuration of DMRS and the receiver implementation (e.g., characteristics).

For example, (e.g., for a given implementation), higher density of reference signals may increase the CE accuracy (e.g., and the overhead), and may decrease the spectral efficiency. For multi-user multiple-input multiple-output (MU-MIMO) a higher density of reference signals may reduce the scope for spatial-multiplexing.

For example, (e.g., for a given implementation) performing channel estimation across a larger number of physical resource blocks (PRBs) may allow to improve performance (e.g., in a case where the delay spread is small, e.g., negligible). Increasing the number of PRBs for the CE (which may be referred to as “bundling”) may reduce resolution for frequency-selective precoding.

For example, (e.g., for a given implementation) MU-MIMO may be based on code division multiplexing (CDM) to differentiate antenna ports sharing the same resource elements (REs). For example, adding pilot REs across additional symbols may allow to increase CDM capability for higher order MIMO.

For example, (e.g., for a given implementation), with a same density of reference signals, the positions of pilots on the resource grid may impact receiver computational complexity (e.g., number of extrapolation operations versus interpolation operations).

For example, (e.g., even) with a limited number of options for reference signal configurations (e.g., including patterns that may be available in 5G NR), the (e.g., optimal) selection (e.g., of a DMRS configuration) may be complex to obtain. This may result in inefficient (e.g., user-specific) reference signal configurations which may under-utilize or over-utilize radio resources for pilots, such as e.g., physical resource elements (PREs). The complexity of selecting a configuration of user-specific reference signals may further increase in a case where an increased number of reference signal configurations (e.g., with an increased number of different parameters) is available for selection. There may be, for example, DMRS configurations with flexible DMRS patterns. Embodiments described herein may allow to improve the DMRS configuration selection such that the efficiency of the radio resource utilization for pilots may be improved. Embodiments described herein may further allow to enable DMRS-less transmission of physical channels in 5G NR.

Embodiments described herein may allow to facilitate (e.g., enable) adaptive reference signal transmission through mechanisms which may allow the terminal to indicate (e.g., transmit an indication of) the (e.g., preferred) configuration(s) of reference signal to the network. For example, the indication of the (e.g., preferred) reference signal configuration(s) may be transmitted to the network any of implicitly and explicitly. Embodiments described herein may provide benefits such as any of reducing DMRS resource usage overhead, reducing DMRS signaling overhead and enhancing CE accuracy.

### Adaptive Reference Signal Configuration Overview

Embodiments are described herein with the example of a cellular communication network involving at least a WTRU and a base station. The WTRU may be any type of WTRU, e.g., including any of a smartphone, a sensor, a relay, etc. Embodiments described herein may be applicable to any type of transceiver chain e.g., including multiple antennas at any of (e.g., both) the base station and the WTRU. For the sake of clarity, embodiments are described herein with the example of downlink DMRS. Embodiments described herein are not limited to downlink DMRS and may be applicable to any other reference signals. For example, embodiments described herein may be applicable to any of downlink reference signals (such as e.g., CSI-RS, etc.), and uplink reference signals.

For example, the physical channels in any of downlink and uplink directions may be accompanied with (e.g., user-specific) reference signals (e.g., DMRS), which may also be referred to herein as pilots, in order to facilitate composite channel estimation and coherent demodulation. This may be achieved, for example, by populating PREs (e.g., transmitting reference signals) based on pseudo-random sequences that may be generated based on system parameters (e.g., combination of any of slot number, symbol number, and scrambling identity) which may be known to the receiver. For example, in 5G NR (e.g., basic) DMRS may be supported in a WTRU e.g., without capability signaling.

For example, a configuration of DMRS may include any of a density and a pattern of reference signals in the resource grid, a duration, a starting symbol (e.g., front-loaded DMRS), and cover codes, e.g., in order to differentiate between antenna ports sharing the same time/frequency resources (for any of single-user and multi-user MIMO cases). For example, the set of parameters for DMRS may be different depending on any of the physical channel and the WTRU capability. For example, DMRS may be grouped over a number of (e.g., consecutive) resource blocks where the precoder may be constant such that the receiver may perform wideband channel estimation. For example, the (e.g., specific) selection of DMRS may be carried out by any of higher-layer configuration and dynamic (e.g., DCI-based) signaling. For example, one or more default configurations may be available (e.g., pre-configured) in the WTRU.

Embodiments described herein may enable a terminal of wireless communications (e.g., with appropriate WTRU capability) to assist with the configuration of (e.g., user-specific) reference signals that may be used for composite channel estimation and coherent demodulation of physical channels.

For example, the base station may configure the DMRS accompanying the corresponding physical channels using a number of high-layer parameters and dynamic (DCI-based) signaling. For example, the base station may transmit DMRS configuration information to the WTRU via any type of signaling. For example, the configuration information may indicate one or more default configurations of DMRS. For example, a (e.g., default) configuration of DMRS may include (e.g., indicate) any of the position and density of reference signals in the resource grid (e.g., any of PRBs, slots, ports), cover codes, starting symbol, additional symbols, etc. For example, there may be different reference signal configurations with different parameters (e.g., options) depending on any of the type of physical channel (e.g., PDSCH, PBCH), the WTRU capability, antenna numbers and locations, etc. For example, the DMRS (e.g., pilots) may be generated using pseudo-random sequences (such as e.g., GOLD sequence) based on system parameters which may be known to (e.g., pre-configured in) the receiver. The parameters that may be used to control the sequence generation may include any of scrambling identity, symbol locations, number of OFDM symbols in a slot, etc. For example, after a selection of DMRS settings (e.g., reference signal configuration), the base station may signal (e.g., transmit signaling information indicating) the selection to the WTRU. Selected DMRS settings (e.g., reference signal configuration) may be indicated to the WTRU based on any of a radio resource control (RRC) message, a MAC control element (MAC-CE), and a physical downlink control channel (PDCCH) DCI. For example, the WTRU may perform composite channel estimation and coherent demodulation of the corresponding physical channels based on the DMRS. This may be achieved, for example, through specific receiver filter implementation (e.g., least squares, minimum mean squared error, etc.) which may broadly estimate the composite channel by mapping the transmitted layers onto the receive antennas for the resource blocks that may be scheduled.

For example, the receiver may (e.g., initially) determine the estimates of the channels of the pilot symbols from their known locations in the received slots. For example, an averaging window may be used to reduce the effects of noise.

For example, multi-dimensional interpolation and extrapolation operations may then be used to estimate the missing values from the channel estimation grid.

For example, noise power estimation may be performed to improve performance by comparison of any of direct and average channel estimates.

For example, with the channel estimate, the WTRU may proceed with (e.g., perform) coherent demodulation of pre-coded/beamformed physical channels (e.g., including data symbols). For example, data may be demodulated based on the estimated channel. After the data may have been demodulated, the (e.g., real, current) channel may be obtained (e.g., based on the demodulated data) and may be compared to the estimated channel.

For example, the accuracy of the channel estimation may be obtained, e.g., related to an error (e.g., performance) metric that may be obtained (e.g., measured) on the demodulated data symbol. For example, the error (e.g., performance) metric may be any of a mean-square-error (MSE), bit-error-rate (BER) performance, and an error-vector-magnitude (EVM).

### First Example of Adaptive Reference Signal Configuration Method

For example, a WTRU may have a capability allowing the WTRU to assist (e.g., the base station) with the adaptive configuration and transmission of (e.g., user-specific) reference signal (e.g., DMRS) used for composite channel estimation and coherent demodulation of physical channels. For example, the WTRU may receive configuration information indicating any number of (e.g., anchor, default) reference signal (e.g., DMRS) configurations, where a (e.g., each) reference signal configuration may be associated with an index. For example, the WTRU may store any of the reference signal (e.g., DMRS) configurations and channel estimation measurements in a database that may be accessible (e.g., available) to the device. For example, the WTRU may select (e.g., determine, decide on) the (e.g., preferred) configuration or list of (e.g., preferred) configurations of reference signal (e.g., DMRS) for any number of subsequent transmissions of physical channels. The selection may be performed, using AI/ML-based learning on, for example, stored historical data. In another example, the selection may be based (e.g., only) on (e.g., instantaneous CE) measurements. For example, the WTRU may indicate the (e.g., preferred) configuration or list of (e.g., preferred) configurations of reference signals (e.g., DMRS) for subsequent use (e.g., transmissions) on the physical channels to the network, any of explicitly (e.g., through forwarding the (e.g., preferred) configuration index or indexes through any of uplink control and data channels), and implicitly (e.g., by using any of specific uplink control and data channel resources).

For example, in a first step, the WTRU may be preconfigured with any number of (e.g., anchor, default) DMRS configurations. For example, the WTRU may have been preconfigured e.g., with factory settings. In another example, the WTRU may receive first configuration information (e.g., from the network) indicating any number of (e.g., anchor, default) DMRS configurations. For example, an (e.g., each) reference signal configuration may be associated with an index.

For example, in a second step, the WTRU may receive an indication of the DMRS configuration for transmission of physical channel from the network. The indication of the DMRS configuration may be included in second configuration information that may be received via any of a RRC (e.g., message), a MAC-CE, and a PDCCH (e.g., DCI). For example, the first configuration information and the second configuration information may be received in any of a same message (e.g., transmission) and different messages (e.g., transmissions).

For example, in a third step, the WTRU may use the (e.g., user-specific) reference signals to perform composite CE and coherent demodulation of the corresponding physical channel.

For example, in a fourth step, in a case where the WTRU has this capability, the WTRU may store any of the indicated DMRS configurations (e.g., in terms of any of pattern, density, RBs, antenna ports etc.) and the CE measurements (such as e.g., complex channel coefficients), for example, in a database.

For example, in a fifth step, the WTRU may select (e.g., determine, decide on) the (e.g., preferred) configuration(s) of DMRS for any of a subsequent downlink and uplink transmission. For example, the selection of the (e.g., preferred) configuration(s) of DMRS may be performed with AI/ML-based learning on a history of any of DMRS configuration(s) and CE measurements, that may have been collected e.g., over a period of time. In another example, the (e.g., preferred) configuration(s) of DMRS may be selected based on (e.g., instantaneous) measurements using, for example, CE techniques such as e.g., any of Doppler, delay spread, etc.

For example, in a sixth step, the WTRU may indicate the selected (e.g., preferred) configuration(s) of DMRS to the network, e.g., in a case where a corresponding WTRU capability is enabled. The indication of the determined (e.g., preferred) configuration(s) of DMRS may be transmitted any of explicitly and implicitly. Explicitly transmitting an indication of a reference signal configuration may be referred to herein as transmitting a message including (e.g., explicit) information indicating the selected (e.g., preferred) configuration(s) of reference signal (such as e.g., index(es) of reference signal configurations). The message including (e.g., explicit) configuration selection may be included in any of the physical uplink control channel (PUCCH) and uplink control information (UCI). Implicitly transmitting an indication of a reference signal configuration may be referred to herein as performing a transmission in a (e.g., specific) resource that may be associated with an indication of the selected reference signal configuration (such as e.g., index(es) of reference signal configurations). The (e.g., specific) resource may be, for example, any of a specific PUCCH resource, random access channel (RACH) resource(s), a sounding reference signal (SRS) resource, and a spatial relation information (e.g., spatialrelationInfo) resource etc. For example, it may be indicated that pilot-less transmission may be accommodated (e.g., performed), for example in a case where channel coherence interval is large, or in a case where previous channel estimates may be applicable to a subsequent transmission.

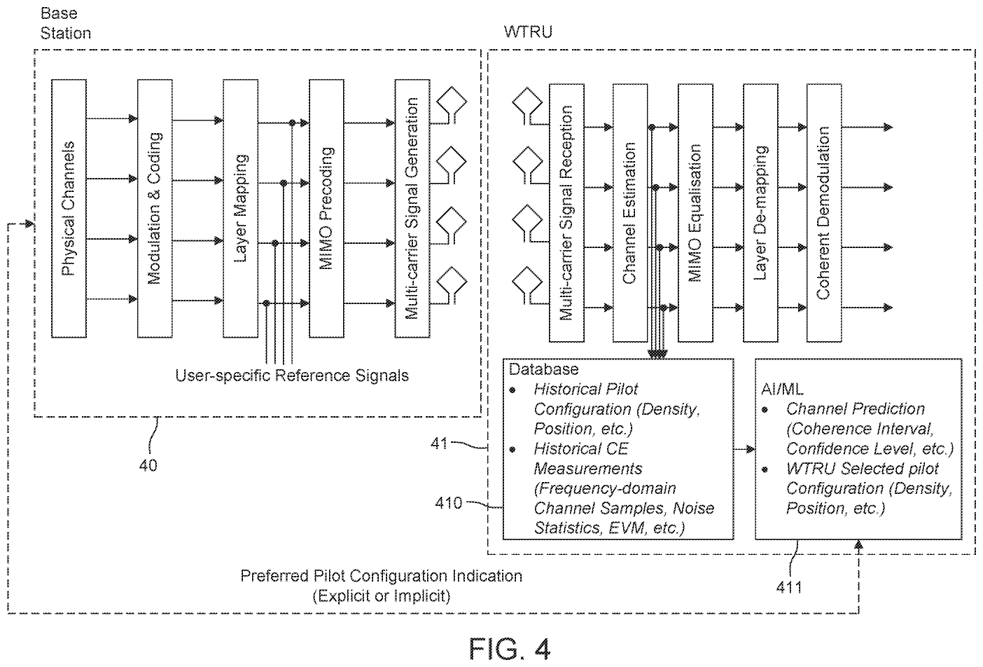

FIG. 4 is a system diagram illustrating the first example of adaptive reference signal configuration method. A WTRU 41 may communicate with a base station 40 via a cellular wireless network. For example, the WTRU 41 may receive a downlink transmission from the base station 40. The WTRU 41 may perform any of multicarrier signal reception, channel estimation, MIMO equalization, layer de-mapping and coherent demodulation. The WTRU 41 may comprise a database 410 for storing historical pilot configuration(s) (e.g., a set of reference signal configurations that may have been used for previous transmissions). For example, the database 410 may comprise historical CE measurements such as e.g., frequency domain channel samples, noise statistics, EVM, etc. For example, The WTRU 41 may comprise an AI/ML module 411 (e.g., executing on a processor) that may be configured to any of perform channel prediction (e.g., coherence interval, confidence level) and select a reference signal configuration (e.g., for a subsequent transmission).

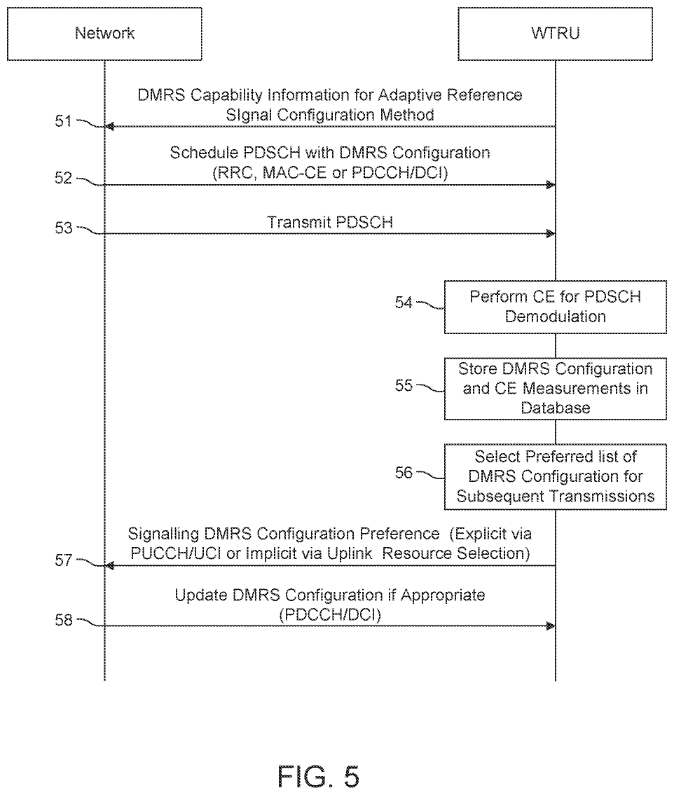

FIG. 5 is a diagram illustrating an example of a message exchange for the first example of adaptive reference signal configuration method.

For example, the WTRU may send a first message 51 comprising capability information indicating a capability of the WTRU to perform an adaptive reference signal method according to e.g., the first example.

For example, the WTRU may receive configuration information 52 indicating a reference signal configuration.

For example, the WTRU may receive a PDSCH transmission 53 (e.g., according to the reference signal configuration).

For example, in a step 54, the WTRU may perform CE and demodulate the PDSCH transmission.

For example, in a step 55, the WTRU may store the reference signal configuration, used in the PDSCH transmission and any CE measurements performed for the PDSCH transmission.

For example, in a step 56, the WTRU may select a (e.g., preferred) (e.g., list of) reference signal configuration(s) for subsequent transmissions.

For example, the WTRU may transmit an indication 57 of the selected reference signal configuration(s) to the base station. The indication transmission may be any of implicit and explicit.

For example, the WTRU may receive information 58 indicating that the reference signal configuration may have been updated.

### Second Example of Adaptive Reference Signal Configuration Method

For example, a base station of wireless communications may adaptively configure the transmission of (e.g., user specific) reference signals (e.g., DMRS) for composite channel estimation and coherent demodulation of any of beamformed and pre-coded physical channels.

For example, in a first step, the base station may indicate (e.g., transmit information indicating) to the WTRU(s) via e.g., downlink control channels any number of anchor (e.g., default) reference signal configurations. For example, a (e.g., each) reference signal configuration may be associated with an index. For example, the base station may receive indication(s) from WTRU(s) (e.g., with certain WTRU capability) of the (e.g., preferred) configuration or list of configurations of reference signal for use in subsequent physical channels. The indication(s) may be received any of explicitly (e.g., through receiving the (e.g., preferred) configuration index(es) through any of uplink control and data channels), and implicitly (e.g., deduced from the WTRU(s) choice of parameters within any of uplink control and data channel resources). For example, the base station may store the reference signal configurations in a database (e.g., in terms of any of pattern, density, RBs, antenna ports etc.). The reference signal configurations may be captured for various (e.g., different) physical channels in any of downlink and uplink from any number of WTRUs.

For example, in a second step, the base station may utilize tools from AI/ML in order to assist the WTRU in terms of any of database storage and AI/ML learning framework complexity. For example, the base station may provide inputs to the WTRU, e.g., in terms of any of number and type of data to be stored and the AI/ML model specifics (e.g., such as any of architecture, learning rate, etc.). For example, the base station may determine parameters of the AI/ML learning scheme to be used at the WTRU(s) for the selection of the (e.g., preferred) configuration(s) of DMRS. For example, historical DMRS configurations may be stored in a database in the network.

For example, in a third step, the base station may communicate (e.g., transmit information indicating) the learning framework (e.g., the inputs) to be used by the WTRU(s) to select the (e.g., preferred) reference signal configuration. Information indicating the learning framework to be used may be transmitted to the WTRU based on any type of signaling (e.g., DCI-based). For example, in case of deep learning, the learning framework information may include indications of any of the architecture, the number of layers, an activation function, etc.

For example, in a fourth step, the WTRU may take this information towards tailored storage (e.g., any of number of RBs, ports, time duration, metric, etc.) of any of the historical DMRS configuration(s), channel estimation measurements. For example, the WTRU may adapt its policy of storing historical data based on the information received from the base station.

For example, in a fifth step, the WTRU may utilize the received information to select the (e.g., preferred) configuration(s) of DMRS for subsequent physical channels. This may be performed based on any of AI/ML-based analysis of collected historical data and through performing CE. The selected reference signal configuration(s) may be associated with (e.g., certain) indexes to facilitate feedback between base station and the WTRU.

For example, in a sixth step, (e.g., in a case where a WTRU capability is enabled), the WTRU may indicate (e.g., transmit information indicating) the selected reference signal configuration(s) any of explicitly (e.g., via including information in PUCCH/UCI) and implicitly by selection of certain uplink resources (e.g., any of a specific PUCCH resource, RACH resource(s), a SRS resource, a spatial relation information (e.g., spatialrelationInfo) resource, etc). The adaptive reference signal configuration method according to the second example may allow to reduce the complexity at the WTRU side by utilizing the network to assist with the AI/ML-based selection of the reference signal configuration at the WTRU.

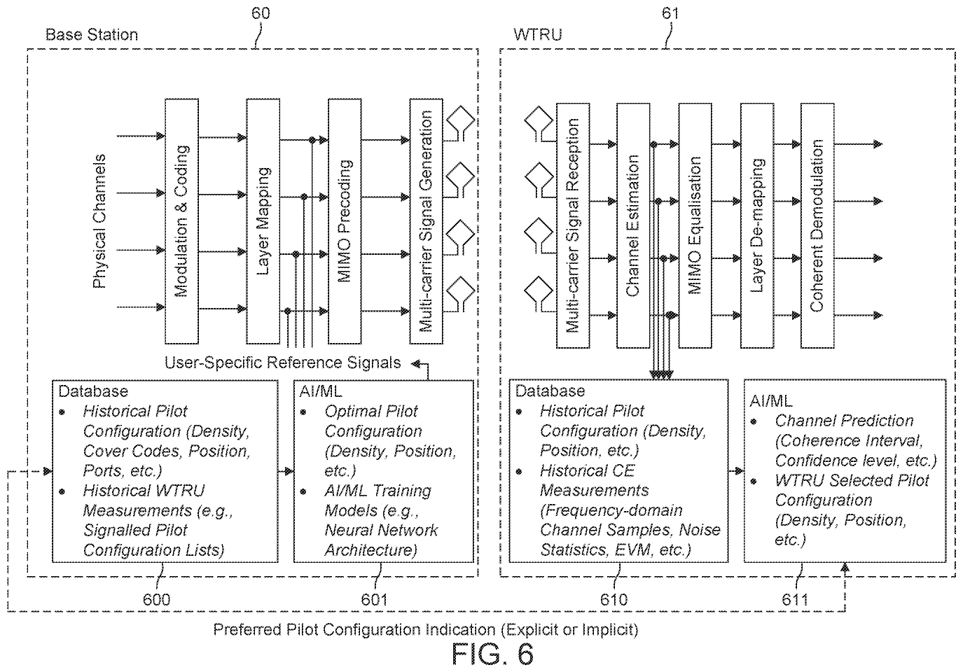

FIG. 6 is a system diagram illustrating the second example of adaptive reference signal configuration method. A WTRU 61 may communicate with a base station 60 via a cellular wireless network. For example, the WTRU 61 may receive a downlink transmission from the base station 60. The WTRU 61 may perform any of multicarrier signal reception, channel estimation, MIMO equalization, layer de-mapping and coherent demodulation. The WTRU 61 may comprise a database 610 for storing historical pilot configuration(s) (e.g., a set of reference signal configurations that may have been used for previous transmissions). For example, the database 610 may comprise historical CE measurements such as e.g., any of frequency domain channel samples, noise statistics, EVM, etc. For example, The WTRU 61 may comprise an AI/ML module 611 (e.g., executing on a processor) that may be configured to any of perform channel prediction (e.g., coherence interval, confidence level) and select a reference signal configuration (e.g., for a subsequent transmission).

For example, the base station 60 may comprise a database 600 for storing historical pilot configuration(s) (e.g., a set of reference signal configurations that may have been used for previous transmissions with the WTRU 61). For example, the database 600 may comprise historical CE measurements such as e.g., signaled pilot configuration lists. For example, the base station 60 may comprise an AI/ML module 601 (e.g., executing on a processor) that may be configured to assist the WTRU is selecting an (e.g., optimal) reference signal configuration (e.g., density, position, etc.). The AI/ML module 601 may further comprise AI/ML training models (e.g., neural network architecture).

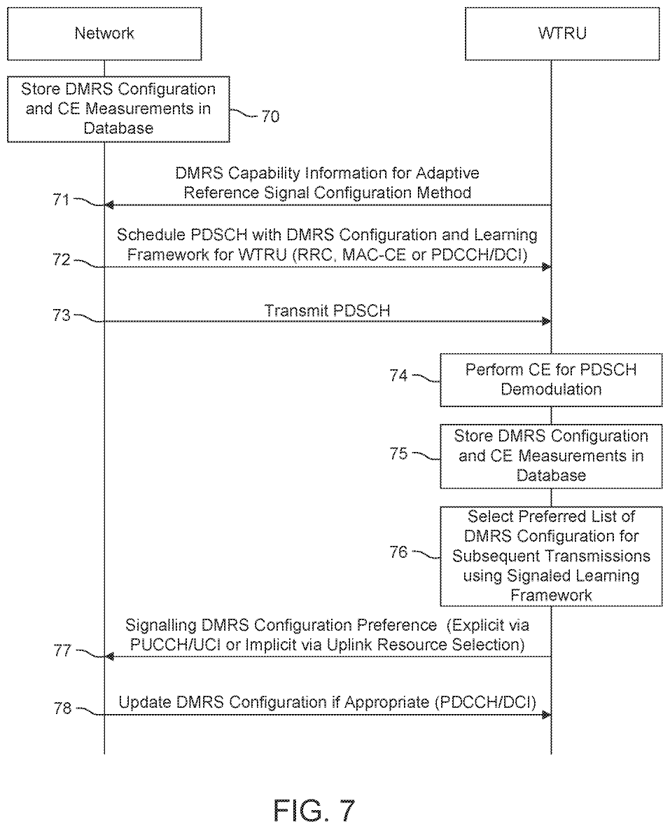

FIG. 7 is a diagram illustrating an example of a message exchange for the second example of adaptive reference signal configuration method.

For example, in a step 70, the base station may store any of reference signal configuration(s) and CE measurements in a database.

For example, the WTRU may send a first message 71 comprising capability information indicating a capability of the WTRU to perform an adaptive reference signal method according to e.g., the second example.

For example, the WTRU may receive configuration information 72 indicating any of a reference signal configuration and a learning framework (e.g., parameters).

For example, the WTRU may receive a PDSCH transmission 73 (e.g., according to the reference signal configuration).

For example, in a step 74, the WTRU may perform CE and demodulate the PDSCH transmission.

For example, in a step 75, the WTRU may store the reference signal configuration, used in the PDSCH transmission and any CE measurements performed for the PDSCH transmission.

For example, in a step 76, the WTRU may select a (e.g., preferred) (e.g., list) of reference signal configuration(s) to subsequent transmissions e.g., using the indicated learning framework. For example, the AI/ML learning module may be configured according to parameters of the indicated learning framework.

For example, the WTRU may transmit an indication 77 of the selected reference signal configuration to the base station. The indication transmission may be any of implicit and explicit.

For example, the WTRU may receive information 78 indicating that the reference signal configuration may have been updated.

### Adaptive Reference Signal Configuration Method Examples

Examples of a method for a WTRU to decide (e.g., select) and indicate the (e.g., preferred) settings of DMRS for subsequent transmission via any of learning (e.g., of any of the historical configurations and measurements) and through performing CE measurements are described herein.

For example, a wireless communications system may comprise a multi-antenna base station communicating with a multi-antenna WTRU where the transmission of data channels may be accompanied with (e.g., user-specific) reference signals in order to facilitate (e.g., assist) composite channel estimation and coherent demodulation at the receiver. For example, the density of reference signal transmission in any of time and frequency may be configured according to any of time and frequency selectivity of the communication channel. For example, the higher the frequency selectivity, the denser the distribution of reference signals may be in the frequency domain. For example, an increased rate of fading in the time domain may be compensated by a more frequent transmission of reference signals.

For example, the WTRU may have the capability (e.g., be capable) of selecting and signaling (e.g., any of explicitly and implicitly) the (e.g., preferred) settings of DMRS (e.g., a preferred reference signal configuration(s)). Capability information indicating such capability of the WTRU to the base station may be transmitted, for example, as part of a RRC message, e.g., within the initial registration process. For example, the capability information may be included in an information element of a RRC message which may allow the WTRU to indicate whether the WTRU supports additional DMRS patterns (e.g., beyond existing DMRS patterns), e.g., without specific capability signaling configuration.

For example, a WTRU (e.g., with the capability of selecting a (e.g., preferred) reference signal configuration) may be configured with (e.g., may receive configuration information indicating) a default configuration for reference signals wherein, for example, reference signals may be placed with an initial configured spacings in any of frequency and time domains. For example, the time/frequency spacings used in the default configuration may be based on a (e.g., maximum possible) separation in time and frequency. In another example, the time/frequency spacings used in the default configuration, may be based on any of a historical configuration, a deployment scenario, a mobility configuration, a MIMO mode, a traffic type, a priority, and a latency, etc. The reference signals placed based on the default configuration may be referred to herein as anchor reference signals.

For example, a WTRU may be configured with (e.g., may receive configuration information indicating) one or more default reference signal configurations. For example, a (e.g., each) default reference signal configuration may be associated with an index.

For example, the WTRU may receive an indication, (such as e.g., an index, or any type of identifier identifying a reference signal configuration), from the base station to indicate one of the (e.g., preconfigured default) reference signal configurations.

For example, the WTRU may (e.g., self) determine a default reference signal configuration based on a measurement, such as e.g., any of Doppler, delay spread, etc. The determination of the default reference signal configuration may be performed, for example, without receiving any indication of a default configuration from the base station.

For example, any of a number N of regions (e.g., ranges) of Doppler values and a number M of regions of delay spread values may be determined. For example, the different regions may correspond to different anchor reference signal configurations. For example, the N and M regions of respectively Doppler and delay spread values may be any of pre-configured in the WTRU and configured by the network (e.g., based on receiving configuration information). The WTRU may determine a default reference signal configuration based on a (e.g., Doppler, delay spread) measurement (e.g., based on the associations between the reference signal configurations and the regions of values).

For example, the WTRU may indicate its determined default reference signal configuration to the base station any of implicitly and explicitly. For example, a WTRU may explicitly indicate its determined configuration by (e.g., transmitting a message including) an index. For example, a WTRU may implicitly indicate the information by using any of a specific PUCCH resource, RACH resource(s), an SRS resource, a spatial relation information (e.g., spatialrelationInfo) resource, etc. (e.g., that may be associated with the reference signal configuration (e.g., index)).

For example, a WTRU may (e.g., attempt to) demodulate the received signal based on the default reference signal configuration(s). For example, a WTRU may perform measurements on the available anchor reference signals to estimate a metric that may correspond to a performance attribute, such as e.g., the accuracy of the channel estimation. For example, the WTRU may determine whether the measured metric matches any of a (e.g., configured) range and threshold(s) that may be associated with a (e.g., successful) operation of the channel estimator. For example, the accuracy of the channel estimation may be measured through any number of key performance indicators (KPI), such as e.g., any of a correlation coefficient, measuring the quality of the channel prediction and a mean square error (MSE), reflecting the difference between the estimated channel and the (e.g., real, current) channel.

For example, in a case where the WTRU determines that the measured metric does not match any of a (e.g., configured) range and threshold(s), the WTRU may request for (e.g., send information requesting) an increase or decrease in the density of reference signals in any of the time and the frequency domains. For example, the WTRU may use separate indicators for time and frequency indication. For example, a grid of reference signals with highest possible density of reference signals in (e.g., both) frequency and time span may be determined (e.g., defined). For example, a WTRU may indicate its (e.g., preferred) density for a (e.g., each) domain by (e.g., transmitting) information indicating a relative change (such as e.g., a simple up/down command, where, for example, an up command may indicate an increase in density of reference signals) by at least one step, and vice versa. For example, considering any of the reference signal frequency and time resource utilization being any value from 0 to 100%, a step may be defined as (e.g., associated with) a (e.g., fixed) percentage increase (or decrease) in density of reference signals. E.g., 0% in time and 0% in frequency occupancy may correspond to pilot-less transmission. In another example, there may be a set of reference signal configurations with different densities of reference signals (which may be any of uniformly and not uniformly distributed). Indicating changing (e.g., increasing or decreasing) by one step may indicate changing to the reference signal configuration of next (e.g., higher or lower) density of reference signals in the set of reference signal configurations.

For example, in a case where the WTRU determines that the measured metric does not match any of a (e.g., configured) range and threshold(s), the WTRU may indicate (e.g., transmit information indicating) any of a (e.g., preferred) density of reference signals for a (e.g., each) domain, and any measured metric, etc. In a first example, a WTRU may transmit information reporting (e.g., indicating) the measured correlation (e.g., between the estimated channel and the real channel) for a (e.g., each) domain. The reported correlation value may be an indicator of the channel estimation accuracy. For example, a (e.g., each) level of correlation may trigger a different reference signal pattern. For example, in a case where the reported correlation values are within a (e.g., desired) range of values, no new reference pattern may be transmitted (e.g., subsequent transmissions may be performed by the base station based on the same reference signal configuration). In a case where the reported correlation values are not in the (e.g., desired) range of values, e.g., below or above (e.g., configured) thresholds, a WTRU may receive subsequent transmissions from the base station with an updated reference signal configuration (e.g., with a new pattern). For example, the thresholds may be any of pre-configured in the WTRU and received from the network via configuration information. In a second example, a WTRU may determine (e.g., and adopt) a pattern from e.g., a set of preconfigured patterns, and may indicate the adopted reference signal pattern, e.g., any of explicitly by e.g., an index and implicitly by transmission of an uplink resource. For example, a WTRU may explicitly indicate its determined configuration by an explicit transmission of information indicating an index. For example, the WTRU may implicitly indicate the determined reference signal configuration by using any of a specific PUCCH resource, RACH resource(s), a SRS resource, and a spatial relation information (e.g., spatialrelationInfo) resource, etc.

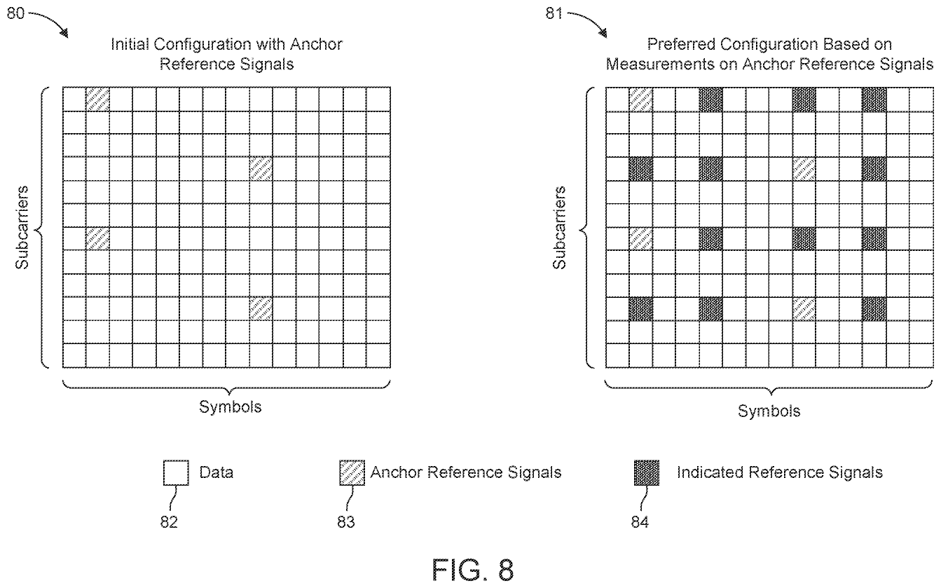

FIG. 8 is a diagram illustrating an example of a reference signal adaption. For example, an initial resource grid 80 may correspond to a default (e.g., initial) reference signal configuration. The initial resource grid may comprise resources blocks that may be allocated to data 82 and to anchor reference signals 83. For example, a subsequent resource grid 81, may have been obtained based a (e.g., preferred) reference signal configuration that may have been selected through any of AI/ML-based learning and measurements of the CE performance. The subsequent resource grid 81 may comprise resource blocks that may be allocated to additional reference signals 84, resulting in a denser distribution of reference signals for (e.g., both) the time and the frequency domains.

For example, future transmissions of the indicated reference signal (e.g., corresponding to the (e.g., preferred) reference signal configuration) may begin within a number X of time-units from a reference point in time (X being any integer value). The number X of time units may be any of fixed, e.g., one slot from a reference point in time, semi-statically and dynamically configured by the network (e.g., indicated in configuration information that may be received from the network). In a case where the number X of time units is (e.g., semi-statically, dynamically) configured by the network, the WTRU may indicate (e.g., transmit information indicating) a (e.g., supported) time interval as part of capability information (e.g., signaling) that may be transmitted to the network such that the network may transmit configuration information indicating a number X of time units larger than the indicated (e.g., supported) time interval.

After the WTRU may have transmitted an indication of the (e.g., preferred, requested) reference signal pattern, the WTRU may receive any of an implicit and explicit indication indicating whether the (e.g., preferred, requested) reference signal pattern is accepted by the network.

In an example of explicit indication, the WTRU may receive explicit (e.g., acceptance, rejection) indication by a dynamic indication, such as e.g., information received in any of a MAC control element (MAC CE) and a DCI.

In an example of implicit indication, the WTRU may detect implicit (e.g., acceptance, rejection) indication based on an association of usage of a (e.g., specific) resource that e.g., may be associated with the requested reference signal pattern, (such as e.g., receiving a (e.g., new) grant associated with the (e.g., specific) resource in any of time and frequency). For example, in a case where the WTRU receives (e.g., new) scheduling information in a shorter time than the configured number X of time units, the WTRU may determine that the request for a new RS pattern may not have been accepted or may not have been received.

In another example, the WTRU may determine whether the request for a new RS pattern has been accepted or not by a blind processing of the received RSs that may arrived (e.g., be received) after the number X of time units. For example, the WTRU may detect anew RS pattern by performing any of examining (e.g., analyzing, processing) the resources associated with the requested pattern, power measurement, descrambling according to the cover code, scrambling ID, etc.

For example, in a case where the WTRU determines that the requested configuration has not been activated within the (e.g., configured) time-window, this may be interpreted as a decoding failure at the base station. For example, the WTRU may re-transmit the indication of the (e.g., preferred) reference signal configuration.

In another example, the indication of the (e.g., preferred) reference signal configuration may be acknowledged by the base station. E.g., the WTRU may receive an explicit indication of the updated reference signal pattern (e.g., configuration) through e.g., DCI/PDCCH, as an acknowledgement of the (e.g., preferred) reference signal configuration indication.

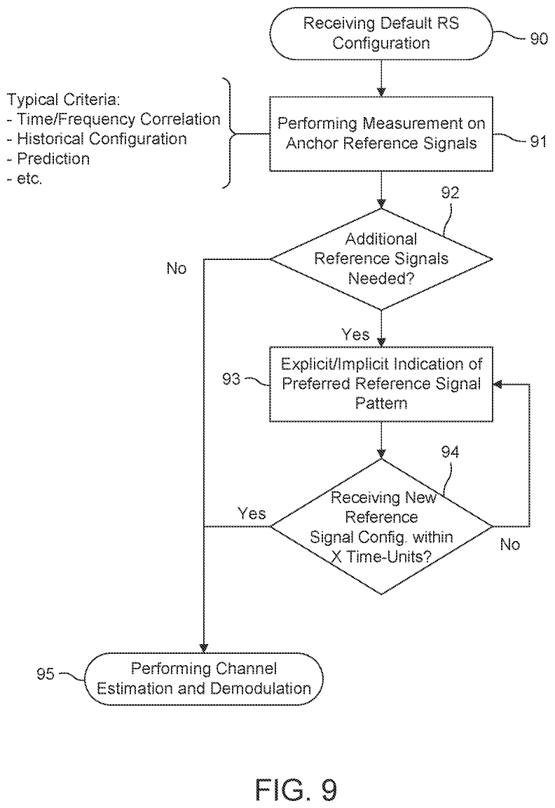

FIG. 9 is a diagram illustrating an example of a procedure for reference signal adaptation.

For example, in a step 90, configuration information indicating one or more default reference signal configurations may be received by the WTRU.

For example, in a step 91, the WTRU may perform measurements on anchor reference signals. For example, the WTRU may estimate any of time and frequency correlation among the available reference signals of the default reference signal configuration(s).

For example, in a step 92 the WTRU may determine whether any of the measured time and frequency correlation values match an (e.g., expected) threshold for the WTRU channel estimator. For example, the channel estimator threshold(s) may be any of pre-configured in the WTRU and received from the network via configuration information.

For example, in a case where any of the measured time and frequency correlation values do not match the channel estimator threshold(s), the WTRU may (any of explicitly and implicitly) indicate a (e.g., preferred) reference signal configuration, in a step 93. For example, the WTRU may indicate a request for transmission of additional reference signals by the base station.

For example, in a step 94, the WTRU may determine whether additional reference signals are received from the base station within a time window (e.g., corresponding to X time units from a reference point in time, such as e.g., the indication transmission). In a case where it is determined that no additional reference signal has been received before the X time units have elapsed, the WTRU may re-transmit an indication of a (e.g., preferred) reference signal configuration in the step 93. In a case where it is determined that an additional reference signal has been received before the X time units have elapsed, the WTRU may perform channel estimation and demodulation based on the additional reference signals in a step 95.

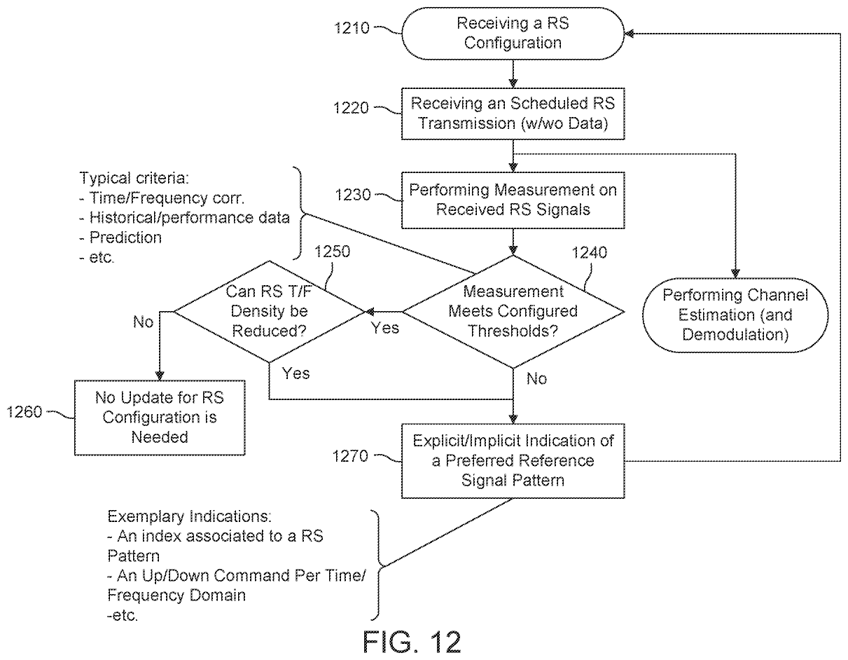

FIG. 12 is a diagram illustrating an example of a method for reference signal adaptation by which the density of reference signals of a reference signal configuration may be modified (e.g., any of increased and reduced) in any of time and frequency domains. For example, reference signals within a reference signal configuration may be of a density in any of time and frequency, and there may be different densities of reference signals for different reference signal configurations (e.g., in a plurality of reference signal configurations). For example, in a step 1210, the WTRU may receive configuration information indicating an initial (e.g., default) RS configuration(s) that may be followed by a (e.g., scheduled) transmission 1220 of RS, which may or may not be accompanied by a data transmission. For example, the initial (e.g., default) RS configuration information may include information indicating a set of (e.g., basic) RSs, e.g., anchor RSs. Anchor RSs may allow to provide an initial capability for channel estimation. For example, the WTRU may receive configuration information indicating one or more (e.g., performance) criteria (such as e.g., thresholds) to be used in the determination (e.g., selection) of DMRS pattern. The one or more (e.g., performance) criteria (e.g., threshold(s)) may relate to (e.g., different) radio transmission characteristics. There may be, for example, different (e.g., performance) criteria (e.g., thresholds) for channel variation in time and in frequency. For example, in a step 1230, the WTRU may perform (e.g., channel estimation) measurement(s) with respect to the anchor RS, such as e.g., channel estimation accuracy, and may compare the performed measurement against one or more (e.g., configured) criteria (e.g., performance measurement thresholds), for example in a step 1240. For example, the WTRU may use additional information based on historical performance (e.g., measurements), e.g., prior (e.g., optimum, selected) RS settings in a (e.g., given) channel condition and mobility. Depending on whether the measured performance satisfies or fails to satisfy one or more of (e.g., configured) criteria (e.g., performance measurement thresholds), the WTRU may determine whether to maintain or to change the RS density in any of time and frequency. For example, in a case where the WTRU determines that the measured performance satisfies one or more (e.g., configured) criteria (e.g., performance measurement thresholds) in any of time and frequency, the WTRU may determine, in a step 1250 whether the density of reference signals of the RS configuration may be reduced (by e.g., comparing the density of reference signals of the RS configuration to a density bound of reference signals) in any of time and frequency. In a case where the WTRU determines that the density of reference signals of the RS configuration may be reduced (e.g., in any of time and frequency), the WTRU may transmit any of an implicit and an explicit indication of a density change (e.g., in any of time and frequency) in a step 1270. In a case where the WTRU determines that the density of reference signals of the RS configuration may not be reduced (e.g., in any of time and frequency), the WTRU may not transmit any implicit or explicit indication of a density change in a step 1260.

In case where the WTRU determines to change a density of reference signals (e.g., in any of time and frequency), the WTRU may transmit information indicating one of (e.g., preconfigured) RS patterns (e.g., configurations). In another example, (e.g., in case of a density change), the WTRU may request any of an increase and a decrease in RS density in any of frequency and time by transmitting information indicating a relative change such as e.g., any of an up command and a down command indicating to any of increase and decrease the density of reference signals in any of time and frequency. For example, the transmitted information may indicate an index value that may be associated with any of an absolute change and a relative change. For example, an index value associated with an absolute change may indicate an index of the selected reference signal configuration. In another example, an index value associated with a relative change (e.g., up, down, increase, decrease) may indicate a second density of second reference signals of the selected second reference signal configuration(s) relative to a first density of first reference signals of the current (e.g., default) reference signal configuration(s). For example, the change in densities of reference signals may be indicated by at least one (e.g., any number of) step according to any embodiments described herein. For example, the transmitted information (e.g., indicating the selected reference signal configuration) may be selected as an index value based on the relative change in density of reference signals between the current (e.g., default) reference signal configuration(s) and the selected reference signal configuration(s).

For example, a method may be implemented in a WTRU. The method may comprise:
receiving, from a base station, a transmission according to one or more default reference signal configurations;
performing a channel estimation measurement for the received transmission based on the default reference signal configuration;
selecting one or more reference signal configurations to be used for a subsequent transmission, wherein the one or more reference signal configurations may be selected from a plurality of reference signal configurations based on the channel estimation measurement; and
transmitting an indication of the selected one or more reference signal configurations to the base station.

For example, configuration information may be received, where the configuration information may indicate any of the default RS configuration(s) and the plurality of RS configurations.

For example, the subsequent transmission may be any of a downlink and an uplink transmission.

For example, the indication may be any of explicit (e.g., based on explicit information) and implicit (e.g., based on a transmission in a specific resource)

The indication may include different types of indication such as e.g., any of an index associated with a RS pattern (e.g., configuration), up/down command to increase/decrease density of reference signals.

For example, the selection of the RS configuration(s) may be based on AIML (e.g., performed on a history of CE measurements).

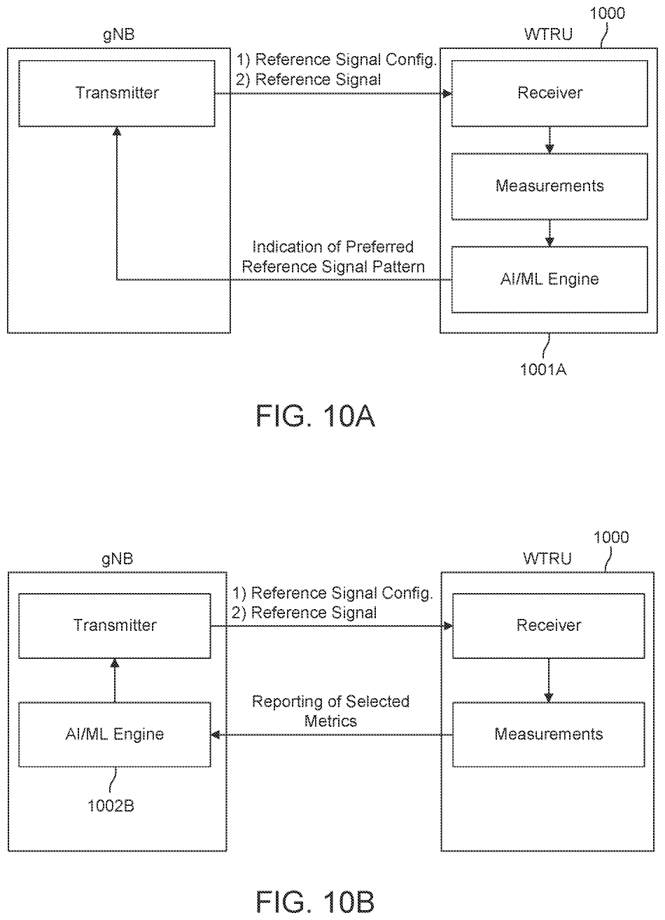

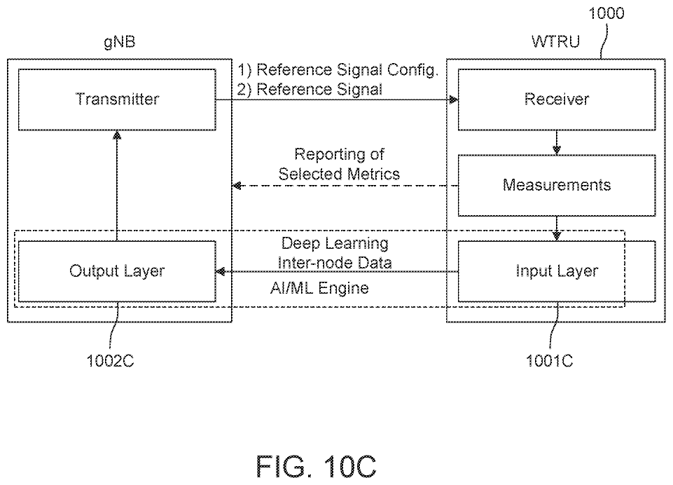

FIGS. 10A, 10B and 10C are three diagrams illustrating three examples of AI/ML-based determination of a reference signal configuration. There may be different examples of different architectures of AI/ML-based determination of a reference signal configuration. The three architectural examples are described as examples and not as limitations of embodiments described herein. For example, the described AI/ML block and the example of deep learning may be merely seen as an exemplary solution to represent a processor engine that may analyze and determine a (e.g., preferred) reference signal pattern. (e.g., configuration). Any other types and architectures of adaptive processing engine may be applicable to embodiments described herein.

FIG. 10A is a diagram illustrating a first example of AI/ML-based determination of a reference signal configuration. For example, a WTRU 1000 may receive configuration information indicating an initial (e.g., default) reference signal configuration(s). For example, the WTRU 1000 may perform some measurements to evaluate at least one set of performance metrics, such as e.g., any of MSE and correlation coefficients, where a set of performance metrics may include any number of measurements. Performance metrics may be referred to herein as any metric capable of capturing the accuracy of the channel estimation algorithm e.g., in any of the time and the frequency domains. For example, a performance metric may comprise a plurality of measurement points (e.g., values) corresponding to the plurality of reference signals.

For example, the obtained (e.g., evaluated) set of performance metrics may be provided to the AI/ML engine 1001A to determine a (e.g., preferred) reference signal configuration. For example, the WTRU 1000 may indicate (e.g., transmit an indication of) the (e.g., preferred) configuration to the base station in any of an implicit and an explicit manner. For example, transmitting an explicit indication may comprise transmitting (e.g., explicit) information indicating the (e.g., preferred) reference signal configuration (e.g., included in a message transmitted) in any of control and data channels. For example, transmitting an implicit indication may comprise performing a transmission (e.g., of any information) using any of a specific uplink control and a data channel resources (e.g., that may be associated with the (e.g., preferred) reference signal configuration).

For example, the WTRU 1000 may receive a plurality of (e.g., more than one) reference signal sets (e.g., corresponding to a plurality of reference signal configurations) e.g., to converge to a solution (e.g., a preferred reference signal configuration). For example, the reference signal sets may be different in any of shape and form. For example, reference signal sets may differ in pattern density (e.g., in any of time, frequency, and code domains). For example, reference signal sets may differ in the location of pilot symbols across any of symbols and subcarriers. For example, two reference signal sets (e.g., configurations) may have the same density of reference signals in frequency domain (e.g., 10%), and the locations of resource elements including the pilots may be different. For example, a WTRU may be configured with (e.g., fixed) reference signal sets (e.g., or slots) for (e.g., every potential) update of reference signal configuration. In other words, the WTRU may not arbitrarily determine a reference signal configuration that may not belong to the set of configured reference signal configurations. For example, the (e.g., fixed) set of reference signal sets (e.g., configurations) may be any of preconfigured in the WTRU and received from the base station via configuration information.

FIG. 10B is a diagram illustrating a second example of AI/ML-based determination of a reference signal configuration. For example, a WTRU 1000 may receive configuration information indicating an initial (e.g., default) reference signal configuration(s). For example, the WTRU 1000 may perform some measurements to evaluate at least one set of performance metrics, such as e.g., any of MSE and correlation coefficients, where a set of performance metrics may include any number of measurements.

For example, the WTRU may report (e.g., transmit a reporting indication of) the evaluated set of performance metrics to the base station, e.g., any of explicitly (e.g., through any of uplink control and data channels), and implicitly (e.g., by using any of specific uplink control and data channel resources). For example, transmitting an explicit indication of the set of performance metrics may comprise including explicit information indicating the set of performance metrics in any of PUCCH/UCI information element, and a channel state information (CSI) report. For example, an explicit indication may comprise any of an index of a e.g., preconfigured table of performance metric values (e.g., preconfigured list of any of MSE and correlation coefficient values) and (e.g., raw) value(s) of the performance metrics to be reported. For example, transmitting an implicit indication of the set of performance metrics may comprise selecting (e.g., and using for transmission) any of uplink control and data channel resources (such as e.g., any of a PUCCH resource, RACH resource(s), a SRS resource, a spatial relation information (e.g., spatialrelationInfo) resource, etc.), that may be associated with performance metric (e.g., ranges of) values.

For example, the base station may comprise an AI/ML engine 1002B (e.g., running on a processor) that may be configured to process the received report(s) to determine a (e.g., preferred) reference signal configuration. For example, the (e.g., preferred) reference signal configuration may be transmitted to the WTRU as configuration information.

For example, a WTRU may receive a plurality of (e.g., more than one) reference signal sets to report an (e.g., evaluated) set of performance metrics to the base station. For example, a WTRU may be configured with (e.g., fixed) reference signal sets (e.g., or slots) for (e.g., every potential) report of the performance metric. In other words, the base station may not arbitrarily determine a reference signal configuration that may not belong to the set of (e.g., preliminary determined) reference signal configurations.

FIG. 10C is a diagram illustrating a third example of AI/ML-based determination of a reference signal configuration. For example, a WTRU 1000 may receive configuration information indicating an initial (e.g., default) reference signal configuration(s). For example, the WTRU 1000 may perform some measurements to evaluate at least one set of performance metrics, such as e.g., any of MSE and correlation coefficients, where a set of performance metrics may include any number of measurements.

For example, the processing of the AI/ML engine may split in two parts 1001C, 1002C where the input layer may be included in the WTRU and the output layer may be included in the base station. For example, based on the (e.g., evaluated) set of performance metrics that may be provided to the input layer 1001C of an AI/ML engine, the WTRU may report (e.g., transmit reporting indications) of a set of inter-node data to the base station. For example, taking a non-limiting example of deep learning (e.g., involving neural network architecture and parameters), the performance metrics (e.g., any of MSE and correlation coefficients) may be used as inputs (e.g., to the input layer 1001C) in the WTRU, for example, to determine (e.g., select) inter-node data such as e.g., any of weights and biases of layer(s) of a neural network. Running the output layer 1002C at the base station may allow to reduce terminal complexity and to improve overall performances, where some of the learnings and e.g., decision on the reference signal configuration may be performed by the base station, with data going into the output layer provided by the WTRU (which may be referred to herein as inter-node data). In this example the AI/ML engine may be seen as distributed between the WTRU and the base station. The transmission of reporting indication(s) of inter-node data may be any of explicit and implicit.

For example, a WTRU may (e.g., also) report (e.g., transmit a reporting indication of) any additional measurement to the base station. For example, the base station may perform additional processing on the reports that may be received from the WTRU to determine a (e.g., preferred) reference signal configuration.

For example, a WTRU may receive a plurality of (e.g., more than one) reference signal sets to report (e.g., transmit a reporting indication of) any of an evaluated set of performance metrics and inter-node data to the base station. For example, the (e.g., preferred) reference signal configuration may be any of determined by the WTRU and received from the base station according to any example described herein.

For example, a WTRU may be configured with (e.g., fixed) reference signal sets (e.g., or slots) for (e.g., every potential) report of any of the performance metric and inter-node data.

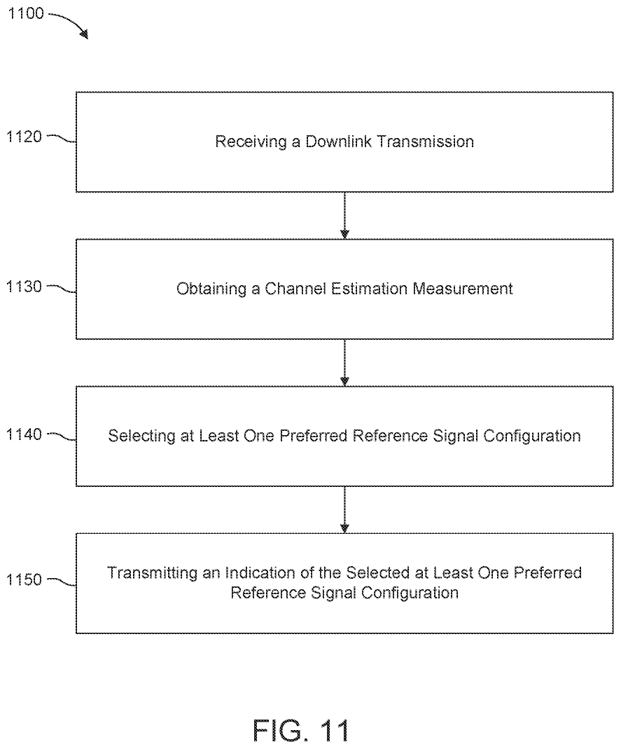

FIG. 11 is a diagram illustrating an example of a method 1100 for adapting a reference signal configuration. For example, the method 1100 for adapting a reference signal configuration may be for use (e.g., implemented) in a WTRU.

For example, in a step 1120, a (e.g., downlink) transmission may be received e.g., from a base station according to one or more first reference signal configurations.

For example, in a step 1130, a channel estimation measurement may be obtained (e.g., performed) for the received (e.g., downlink) transmission based on the one or more first reference signal configurations.

For example, in a step 1140, one or more second reference signal configurations (e.g., to be used for a subsequent transmission) may be selected from a plurality of reference signal configurations based on the channel estimation measurement.

For example, in a step 1150, an indication of (e.g., the selected) one or more second reference signal configurations may be transmitted (e.g., to the base station). For example, in the step 1150, the indication may be transmitted to the base station, the indication may indicate one or more second reference signal configurations to be used for a subsequent transmission, wherein the one or more second reference signal configurations may be selected from a plurality of reference signal configurations based on the channel estimation measurement.

For example, the one or more first reference signal configurations may be any of: (1) preconfigured in the WTRU and/or (2) received from the base station e.g., included in, indicated by first configuration information.

For example, the plurality of reference signal configurations may be any of (1) preconfigured in the WTRU and/or (2) indicated by second configuration information received from the base station.

For example, the first configuration information and the second configuration information may be included in a same message.

For example, the first configuration information and the second configuration information may be included in different messages.

For example, the reference signal configurations may be associated with indexes e.g., in a database.

For example, each of the plurality of reference signal configurations may be associated with an index.

For example, the first configuration information may comprise one or more first indexes indicating the one or more first reference signal configurations.

For example, the indication of the (e.g., selected) one or more second reference signal configurations may comprise (e.g., indicate) one or more second indexes associated with the one or more reference signal configurations (e.g., in the database).

For example, the indication of the one or more second reference signal configurations may indicate a second index associated with one second reference signal configuration.

For example, the reference signal configurations may be of different densities in any of time and frequency.

For example, reference signals within a reference signal configuration may be of a density in any of time and frequency, and there may be different densities of reference signals for different reference signal configurations in the plurality of reference signal configurations.

For example, the indication of the (e.g., selected) one or more second reference signal configurations may indicate one or more densities of reference signals in any of time and frequency for the selected one or more second reference signal configurations.

For example, the indication of the (e.g., selected) one or more second reference signal configurations may indicate an up command or a down command to be applied to the one or more first reference signal configurations for respectively increasing or decreasing a density in any of time and frequency.

For example, the indication of the one or more second reference signal configurations may indicate a relative change (e.g., increasing or decreasing) in density of reference signals in any of time and frequency, from a first density of first reference signals for the one or more first reference signal configurations to a second density of second reference signals for the selected one or more second reference signal configurations.

For example, the indication of the one or more second reference signal configurations may be selected as an index value based on the relative change in density of reference signals between the one or more first reference signal configurations and the selected one or more second reference signal configurations.

For example, the relative change may indicate increasing or decreasing the density of reference signals by a fixed step in any of time and frequency.

For example, the one or more second reference signal configurations may be selected with an increased density of second reference signals in any of time and frequency, on a condition that the performed channel estimation measurement fails to satisfy one or more first (e.g., performance) criteria respectively in any of time and frequency.

For example, the WTRU may receive third configuration information indicating the one or more first (e.g., performance) criteria in any of time and frequency.

For example, the one or more second reference signal configurations may be selected with a decreased density of second reference signals in any of time and frequency, on a condition that the performed channel estimation measurement satisfies one or more second (e.g., performance) criteria respectively in any of time and frequency.

For example, the WTRU may receive fourth configuration information indicating the one or more second (e.g., performance) criteria in any of time and frequency.

For example, the subsequent transmission may be any of a (e.g., subsequent) downlink transmission and a (e.g., subsequent) uplink transmission.

For example, the subsequent transmission may be a downlink transmission and the subsequent transmission may be received using the one or more second reference signal configurations.

For example, the subsequent transmission may be an uplink transmission and the subsequent transmission may be transmitted using the one or more second reference signal configurations.

For example, the indication of the (e.g., selected) one or more second reference signal configurations may comprise first information included in any of a physical uplink control channel and uplink control information.

For example, the indication of the (e.g., selected) one or more second reference signal configurations may be transmitted by transmitting first information indicating the selected one or more second reference signal configurations.

For example, the first information may be included in any of a physical uplink control channel and uplink control information.

For example, the (e.g., indication of the selected) one or more reference signal configurations may be indicated (e.g., transmitted) by a transmission in a resource that may be associated with the selected one or more second reference signal configurations.

For example, the resource may be any of a physical uplink control channel resource, a random-access channel resource, a sounding reference signal resource and a spatial relation information resource.

For example, the selection of the one or more second reference signal configurations may be further based on AI/ML, performed on the (e.g., last performed) channel estimation measurement.

For example, the selection of the one or more reference signal configurations may be further based on AI/ML, performed on a set of (e.g., a history of) channel estimation measurements.

For example, the AI/ML model may have been trained on a set of (e.g., a history of) channel estimation measurements.

For example, second information indicating an AI/ML framework to be used for the selection of the one or more second reference signal configurations may be received from the base station.

For example, the second information indicating the AI/ML framework to be used may be received via a downlink control channel.

For example, inter-node data may be transmitted to the base station, the inter-node data being obtained based on the historical (e.g., history of) channel estimation measurements.

For example, at least one performance metric may be transmitted to the base station, the at least one performance metric being obtained based on at least one estimation measurement.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

For the sake of clarity, satisfying, failing to satisfy a condition (e.g., performance criteria) and “configuring condition parameter(s) are described throughout embodiments described herein as relative to a threshold (e.g., greater or lower than) a (e.g., threshold) value, configuring the (e.g., threshold) value, etc.). For example, satisfying a condition (e.g., performance criteria) may be described as being above a (e.g., threshold) value, and failing to satisfy a condition (e.g., performance criteria) may be described as being below a (e.g., threshold) value. Embodiments described herein are not limited to threshold-based conditions (e.g., performance criteria). Any kind of other condition and parameter(s) (such as e.g., belonging or not belonging to a range of values) may be applicable to embodiments described herein.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1-20. (canceled)

21. A wireless transmit/receive unit (WTRU) comprising circuitry, including any of a transmitter, a receiver, a processor, and a memory, wherein the circuitry is configured for:
receiving, from a base station, a first transmission according to one or more first reference signal configurations;
performing a channel estimation measurement for the first transmission based on the one or more first reference signal configurations; and
transmitting, to the base station, one or more commands indicating to increase or decrease a density of reference signals based on the channel estimation measurement, wherein at least one command of the one or more commands indicates to increase or decrease the density of reference signals in one of time or frequency.

22. The WTRU of claim 21, wherein the at least one command indicates to increase or decrease the density of reference signals by one step in one of time or frequency to a next higher or lower density in a set of densities of reference signals.

23. The WTRU of claim 22, wherein densities of reference signals are uniformly distributed in the set of densities of reference signals.

24. The WTRU of claim 21, wherein the one or more commands comprise a first command and a second command, the first command indicating to increase the density of reference signals in time and the second command indicating to decrease the density of reference signals in frequency.

25. The WTRU of claim 21, wherein the circuitry is configured for receiving information indicating if the one or more commands have been accepted or not.

26. The WTRU of claim 21, wherein the circuitry is configured for determining that no second reference signal configuration corresponding to the one or more commands has been activated in a time window.

27. The WTRU of claim 26, wherein the circuitry is configured for:
blind decoding second transmissions received during the time window; and
analyzing time or frequency resources associated with one or more second reference signal configurations corresponding to the one or more commands.

28. The WTRU of claim 26, wherein the circuitry is configured for retransmitting the one or more commands, based on the determining that no second reference signal configuration corresponding to the one or more commands has been activated in the time window.

29. The WTRU of claim 26, wherein the circuitry is configured for receiving configuration information indicating a first duration of the time window.

30. The WTRU of claim 29, wherein the circuitry is configured for transmitting capability information indicating a second duration of the time window, and wherein the first duration indicated in the configuration information is larger than the second duration indicated in the capability information.

31. A method implemented in a wireless transmit/receive unit (WTRU), the method comprising:
receiving, from a base station, a first transmission according to one or more first reference signal configurations;
performing a channel estimation measurement for the first transmission based on the one or more first reference signal configurations; and
transmitting, to the base station, one or more commands indicating to increase or decrease a density of reference signals based on the channel estimation measurement, wherein at least one command of the one or more commands indicates to increase or decrease the density of reference signals in one of time or frequency.

32. The method of claim 31, wherein the at least one command indicates to increase or decrease the density of reference signals by one step in one of time or frequency to a next higher or lower density in a set of densities of reference signals.

33. The method of claim 32, wherein densities of reference signals are uniformly distributed in the set of densities of reference signals.

34. The method of claim 31, wherein the one or more commands comprise a first command and a second command, the first command indicating to increase the density of reference signals in time and the second command indicating to decrease the density of reference signals in frequency.

35. The method of claim 31, comprising receiving information indicating if the one or more commands have been accepted or not.

36. The method of claim 31, comprising determining that no second reference signal configuration corresponding to the one or more commands has been activated in a time window.

37. The method of claim 36, comprising:
blind decoding second transmissions received during the time window; and
analyzing time or frequency resources associated with one or more second reference signal configurations corresponding to the one or more commands.

38. The method of claim 36, comprising retransmitting the one or more commands, based on the determining that no second reference signal configuration corresponding to the one or more commands has been activated in the time window.

39. The method of claim 36, comprising receiving configuration information indicating a first duration of the time window.

40. The method of claim 39, comprising transmitting capability information indicating a second duration of the time window, wherein the first duration indicated in the configuration information is larger than the second duration indicated in the capability information.
